(19) United States
(12) Patent Application Publication
(10) Pub. No.: US 2007/0072023 A1
(43) Pub. Date: Mar. 29, 2007

(54) Fuel cell unit, information processing apparatus, and power supply control method for information processing apparatus

(76) Inventors: Koji Nakamura, Tokyo (JP); Akihiro Ozeki, Tokyo (JP); Ryoji Ninomiya, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/541,611

(22) Filed: Sep. 28, 2006

Related U.S. Application Data
(63) Continuation of application No. PCT/JP05/05201, filed on Mar. 23, 2005.

(30) Foreign Application Priority Data
Mar. 31, 2004 (JP) 2004-108045

(51) Int. Cl. H01M 8/04

(52) U.S. Cl. 429/22

(57) ABSTRACT

A fuel cell unit according to the present invention includes a connection section used for establishing connection with an external device; fuel cells for generating power to be supplied to the external device through the connection section; a setting switch settable to power generation permission setting for permitting power generation using the fuel cells; and a control section capable of controlling the power generation using the fuel cells, when the setting switch is set to power generation permission setting. The above-described arrangements allow a simple operation for automatically executing the start/stop sequence of power generation in the fuel cell unit in operative association with the start/stop of the external device.

### CROSS-REFERENCE TO RELATED APPLICATION

This application is based upon and claims the benefit of priority from PCT application No. PCT/JP2005/005201 filed Mar. 23, 2005 and Japanese Patent Application No. 2004-108045, filed Mar. 31, 2004, the entire contents of which are incorporated herein by reference.

### BACKGROUND

1. Field

The present invention relates to a fuel cell unit to be connected to an information processing apparatus, the information processing apparatus equipped with the fuel cell unit, and a power supply control method for the information processing apparatus equipped with the fuel cell unit.

2. Description of the Related Art

At present, for example, a lithium ion battery is used as a secondary battery, serving as one of power supply sources for an information processing apparatus. One of the features of the secondary battery is that, compared with a primary battery, which is of a throw-away type, the secondary battery can be repeatedly employed by charging it using a commercial power supply for example.

However, viewed from another aspect, the lithium ion battery, being a secondary battery, must be subjected to charging using the commercial power supply for example.

With a significant improvement in the functionality of information processing apparatuses in recent years, power consumption in information processing apparatuses is on the increase. Accordingly, there are efforts underway to enhance the density of energy provided by the lithium ion battery supplying power to the information processing apparatus, that is, the output energy amount per unit volume or unit mass, of the lithium ion battery. However, it is now difficult to expect a remarkable enhancement in its energy density.

On the other hand, the energy density of a fuel cell is said to be theoretically ten times as high as that of the lithium battery (e.g., see “Fuel Cell 2004 (Nenryou-Denchi 2004)” Nikkei Business Publications, Inc., pp. 49-50 and pp. 64, October 2003). This means that, given that the fuel cell is equal in volume or mass to the lithium ion battery, the fuel cell has potentiality to supply power for longer (e.g., ten times longer) time than the lithium ion battery. This also means that, given that their power supply durations are equal to each other, the fuel cell has a larger potentiality for miniaturization and weight reduction than the lithium ion battery.

Also, if fuel cells are unitized by enclosing a fuel such as methanol into a compact container and used with the compact container replaced in its entirety, the fuel cells need no charging from the outside. Therefore, for example, in a place where there are no AC power supply facilities, the information processing apparatus can be used for a longer time when power is secured by using the fuel cells than when power is secured by using the lithium ion battery.

Furthermore, when attempting to use for a long time the information processing apparatus (e.g., a notebook personal computer) employing the lithium ion battery, a user is subjected to the restriction that the user must use the information processing apparatus in an environment allowing power supply by an AC power supply, since it is difficult to use for a long time the information processing apparatus employing power supplied by the lithium ion battery. In contrast, the using the information processing apparatus by power supplied from the fuel cells allows the information processing apparatus to be used over a longer time period compared with the case where it is used by power supplied from the lithium ion battery. Simultaneously, it can be expected that the user is released from the above-described restrictions.

From the above-described viewpoints, research and development of fuel cells for the purpose of supplying power to information processing apparatuses are progressing, and results thereof have been hitherto disclosed in, for example, JP-A 2003-142137, JP-A 2003-86192 and JP-A 2002-169629.

Fuel cells include a variety of types (e.g., see “Everything of Fuel Cell (Nenryoudenchi-no-subete),” Hironosuke Ikeda, Nippon Jitsugyo Publishing Co., Ltd., August 2001). As being suitable for the information processing apparatus, a direct methanol fuel cell (DMFC) is recommendable from the viewpoints of the miniaturization, weight reduction, and the manageability of fuel. This fuel cell uses methanol as fuel, and is a type in which methanol is directly injected into a fuel electrode without being converted into hydrogen.

To the direct methanol fuel cell, the concentration of methanol to be injected into the fuel electrode is of importance. Too high concentration thereof reduces the power generation efficiency, thereby resulting in insufficient performance. This is attributable to the phenomenon in which part of methanol serving as fuel undesirably passes through an electrolyte film (solid polymer electrolyte film) sandwiched between the fuel electrode (negative electrode) and an air electrode (positive electrode), this phenomenon being referred to as a crossover phenomenon. Use of high-concentration methanol enhances the crossover phenomenon, whereas injection of low-concentration methanol into the fuel electrode reduces the crossover phenomenon.

High performance is easily secured when low-concentration methanol is used as fuel, but the needed volume of the fuel becomes larger (e.g., ten times larger) than when high-concentration methanol is used as fuel, thereby resulting in an upsized fuel container (fuel cartridge).

With this being the situation, while implementing the miniaturization of the fuel cartridge by accommodating high-concentration methanol therein, the methanol concentration is reduced by circulating water occurring at power generation using compact pumps and valves, and diluting the high-concentration methanol before being injected into the fuel electrode, whereby the crossover phenomenon can be reduced. This method allows an enhancement of power generation efficiency. Hereinafter, pumps and valves and the like for circulating water and the like occurring at power generation are referred to as auxiliary equipment, and such a circulation system is referred to as a dilution circulation system.

In this manner, a fuel cell unit having high power generation efficiency can be implemented by using diluted methanol while achieving the reduction in the overall size and weight of the fuel cell unit (as disclosed in “Fuel Cell 2004 (Nenryou-Denchi 2004)” Nikkei Business Publications, Inc., pp. 49-50 and pp. 64, October 2003).

In the direct methanol fuel cell, adoption of a dilution circulation system allows reduction in the overall size and weight of the fuel cell unit, as well as enhances power generation efficiency, leading to a high-output fuel cell unit.

In the dilution circulation system, in order to circulate water and the like, auxiliary equipment such as pumps, valves is required. In order to start power generation using the fuel cell unit, control for driving the auxiliary equipment is needed.

When power generation by fuel cell unit is to be stopped, the power generation efficiency at next time power generation can be improved by, after having stopped a supply of the generated power, performing cool-down processing in which the auxiliary equipment is driven for a predetermined time period, and then performing control for stopping the auxiliary equipment.

However, for the user employing an information processing apparatus equipped with a fuel cell unit, or the information processing apparatus to which fuel cell unit is connected through a connection section, it complicates handling of the information processing apparatus that new handling is added in association with control peculiar to the fuel cell unit. For the user, it is desired that, irrespective of whether the power supply for the information processing apparatus is a conventional secondary battery or a fuel cell unit, the handling method for them be the same. In other words, desired handling is such one that does not make the user aware that the power supply is a fuel cell unit.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an external view of a fuel cell unit according to an embodiment of the present invention.

FIG. 2 is an external view showing a state where an information processing apparatus according to the embodiment of the present invention is connected to the fuel cell unit shown in FIG. 1.

FIG. 3 is a schematic diagram chiefly showing the power generation section of the fuel cell unit.

FIG. 4 is a schematic diagram showing a state where the information processing apparatus is connected to the fuel cell unit.

FIG. 5 is a schematic diagram explaining the fuel cell unit and information processing apparatus according to the first embodiment of the present invention.

FIG. 6 is a state transition diagram of the fuel cell unit and information processing apparatus.

FIG. 7 is a table showing main control commands with respect to the fuel cell unit.

FIG. 8 is a table showing main power supply information on the fuel cell unit.

FIG. 9 is a logic diagram showing transmission conditions of an operation ON command with respect to the information processing apparatus.

FIG. 10 is a logic diagram showing transmission conditions of an operation OFF command with respect to the information processing apparatus.

FIG. 11 is a state transition diagram of the fuel cell unit and information processing apparatus in emergency stop.

FIG. 12 is a logic diagram showing transmission conditions of an emergency stop command with respect to the information processing apparatus.

### DETAILED DESCRIPTION

Hereinafter, a fuel cell unit, information processing apparatus, and power supply control method for the information processing apparatus, according to a first embodiment of the present invention will be described with reference to the accompanying drawings.

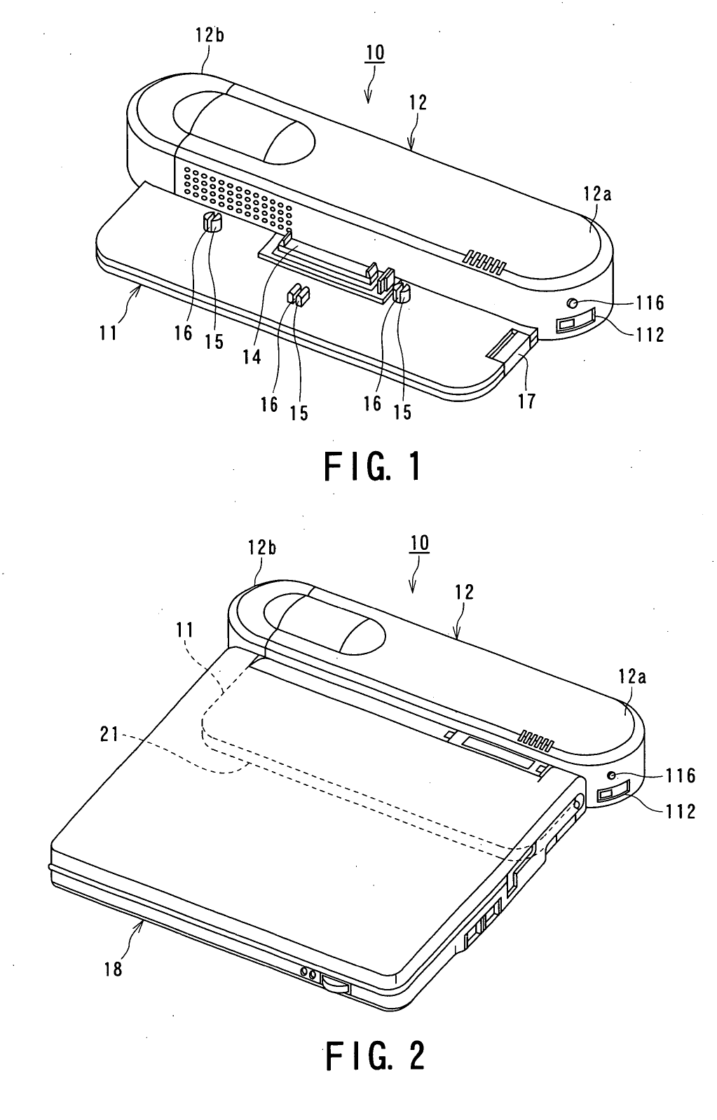

FIG. 1 is an external view of a fuel cell unit according to the embodiment of the present invention. As shown in FIG. 1, the fuel cell unit 10 comprises a mounting section 11 for mounting the rear part of an information processing apparatus such as a notebook personal computer, and a fuel cell unit body 12. The fuel cell unit body 12 incorporates a DMFC stack for generating power based on an electrochemical reaction, and auxiliary equipment (pumps, valves and the like) for injecting and circulating methanol, serving as fuel, with respect to the DMFC stack, and air.

Within a unit case 12a of the fuel cell unit body 12, and for example, at the left end in FIG. 2, a detachable fuel cartridge (not shown) is incorporated therein. A cover 12b is removably provided so that the fuel cartridge can be replaced.

The information processing apparatus is mounted on the mounting section 11. On the top surface of the mounting section 11, there is provided a docking connector 14 serving as a connection section for establishing the connection with the information processing apparatus. On the other hand, for example, at the rear on the bottom surface of the information processing apparatus 18, there is provided a docking connector 21 (not shown) serving as a connection section for establishing connection with the fuel cell unit 10, and it is mechanically and electrically connected with the docking connector 14 of the fuel cell unit 10. Sets of positioning protrusions 15 and hooks 16 are each provided at three positions on the mounting section 11, and these sets of positioning protrusions 15 and hooks 16 are inserted into three holes correspondingly provided at the rear on the bottom surface of the information processing apparatus 18.

When attempting to detach the information processing apparatus from the fuel cell unit 10, an eject button 17 in the fuel cell unit 10 shown in FIG. 1 is pushed, whereby a locking mechanism (not shown) is released and allows the fuel cell unit 10 to be easily detached.

On the right side surface for example, of the fuel cell unit body 12, there are provided a power generation setting switch 112 and a fuel cell operation switch 116.

The power generation setting switch 112 is a switch for the user to set in order to permit or prohibit power generation in the fuel cell unit 10, and constituted of a slide type switch for example.

The fuel cell operation switch 116 is used, for example, when only power generation in the fuel cell unit 10 is stopped while maintaining the operation of the information processing apparatus 18, in a state where the information processing apparatus 18 is operating using power generated by the fuel cell unit 10. In this case, the information processing apparatus 18 maintains its operation using power of the secondary battery incorporated therein. Here, the fuel cell operation switch 116 is constituted of a push switch for example.

FIG. 2 is an external view showing a state where the information processing apparatus 18, such as a notebook personal computer, is placed onto and connected to the mounting section 11 of the fuel cell unit 10.

Possible shapes and sizes of the fuel cell unit 10, and possible shapes and locations of the docking connector 14 shown in FIGS. 1 and 2 include a variety of kinds.

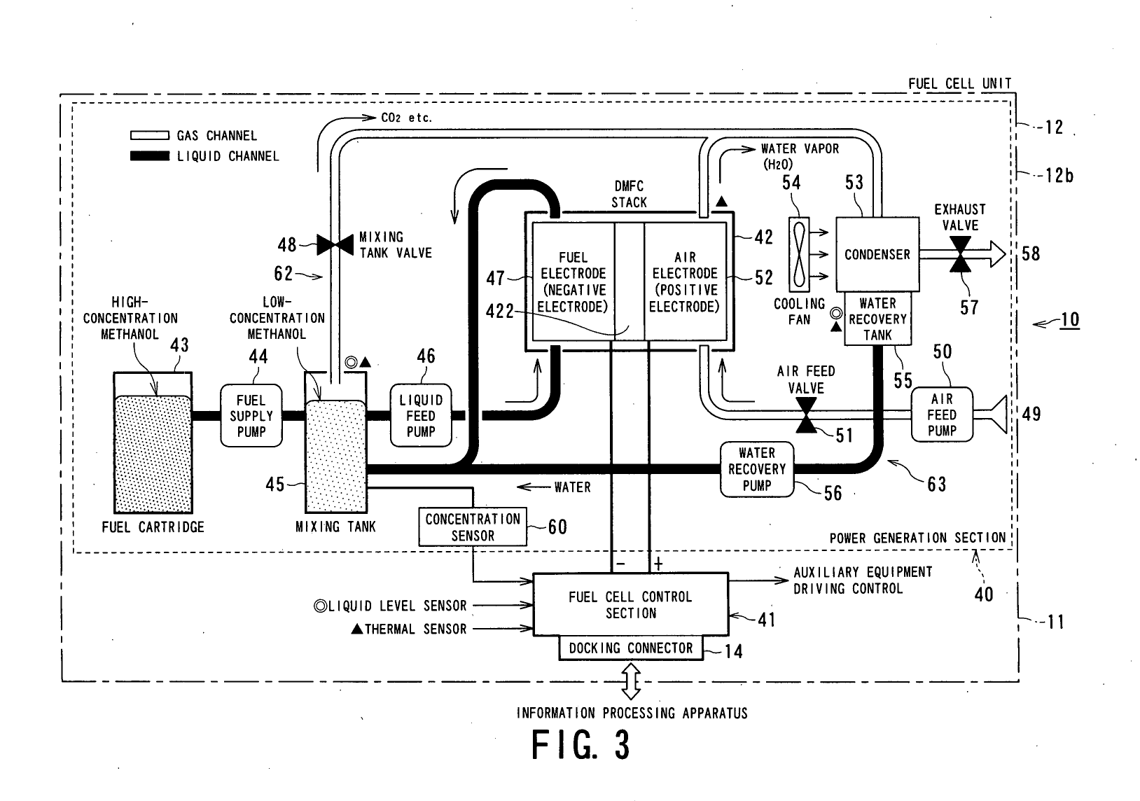

FIG. 3 is a schematic diagram showing the fuel cell unit 10 according to the embodiment of the present invention. In particular, the DMFC stack and auxiliary equipment provided therearound will be described in detail.

The fuel cell unit 10 includes a power generation section 40 and a fuel cell control section 41 serving as a control section of the fuel cell unit 10. The fuel cell control section 41 performs control with respect to the power generation section 40, and besides, it has the function as a communication control section for communicating with the information processing apparatus 18.

The power generation section 40 has a DMFC stack 42 playing a predominant role in performing power generation, and besides, it has a fuel cartridge 43 for accommodating methanol serving as fuel. High-concentration methanol is enclosed in the fuel cartridge 43. The fuel cartridge 43 is removably formed so as to be easily replaceable when it runs out of fuel.

Generally, in the direct methanol fuel cell, the crossover phenomenon must be reduced to enhance the power generation efficiency. An effective method serving this purpose is to dilute high-concentration methanol to a low concentration and inject it into the fuel electrodes 47. To implement this method, the fuel cell unit 10 adopts a dilution circulation system 62, in which the auxiliary equipment 63 necessary for the implementation of the dilution circulation system 62 is arranged in the power generation section 40.

The auxiliary equipment 63 includes one provided in a fluid channel and one provided in a gas channel.

Regarding the connection relationships of the auxiliary equipment 63 provided in a fluid channel, the output section of the fuel cartridge 43 is connected through piping to the fuel supply pump 44, and further the output section of the fuel supply pump 44 is connected to a mixing tank 45. Also, the output section of the mixing tank 45 is connected to a liquid feed pump 46, and the output section of the liquid feed pump 46 is connected to fuel electrodes 47 of the DMFC stack 42. Moreover, the output section of the fuel electrodes 47 is connected through piping to the mixing tank 45. Furthermore, the output section of a water recovery tank 55 is connected through piping to a water recovery pump 56, and the water recovery pump is connected to the mixing tank 45.

On the other hand, in the gas channel, air feed pump 50 is connected through the air feed valve 51 to the air electrodes 52 of the DMFC stack 42. The output section of the air electrodes 52 is connected to the condenser 53. Connection is made also from the mixing tank 45 through a mixing tank valve 48 to the condenser 53. The condenser 53 is connected through an exhaust valve 57 to an exhaust port 58. Also, a cooling fan 54 is provided in the vicinity of the condenser 53.

Next, description of the power generating mechanism of the power generating section 40 of the fuel cell unit 10 will be made along flows of fuel and air (oxygen).

First, the high-concentration methanol in the fuel cartridge 43 flows into the mixing tank 45 under the fuel supply pump 44. Within the mixing tank 45, the high-concentration methanol is mixed with recovered water and/or low-concentration methanol (residual part of a power generating reaction) issued from the fuel electrodes 47, to thereby be diluted, resulting in low-concentration methanol. The concentration of the low-concentration methanol is controlled so that a concentration (e.g., 3 to 6 percent) allowing the implementation of high power generation efficiency can be maintained. In this control, based on information from a concentration sensor 60 for example, the amount of high-concentration methanol to be supplied to the mixing tank 45 by the fuel supply pump 44, is controlled. Alternatively, this control can be implemented by controlling the amount of water circulated to the mixing tank 45 using the water recovery pump 56 or the like.

The methanol aqueous solution diluted in the mixing tank 45 is pressurized by the liquid feed pump 46, and injected into the fuel electrodes (negative electrodes) 47 of the DMFC stack 42. In each of the fuel electrodes 47, an oxidation reaction of methanol occurs and electrons are generated. Hydrogen ions (H⁺) produced in the oxidation reaction pass through a solid polymer electrolytic membrane 422 in the DMFC stack 42 and reaches each of the air electrodes (positive electrodes) 52.

On the other hand, carbon dioxide produced by the oxidation reaction occurring in each of the fuel electrodes 47 is circulated to the mixing pump 45 along with the methanol aqueous solution that has not been used in the reaction. After having been vaporized in the mixing tank 45, the carbon dioxide heads toward the condenser 53 through the mixing tank valve 48, and is ultimately discharged from the exhaust port 58 through the exhaust valve 57.

Meanwhile, the flow of air (oxygen) is taken in from an intake port 49, and after having been pressurized by the air feed pump 50, it is injected into the air electrodes (positive electrodes) 52 through the air feed valve 51. In each of the air electrodes 52, a reduction reaction of oxygen (O₂) progresses, so that water (H₂O) is produced as water vapor, from electrons (e⁻) issued from an external load, hydrogen ions (H⁺) issued from the fuel electrode 47, and oxygen (O₂). This water vapor is discharged from the air electrodes 52 and enters the condenser 53. In the condenser 53, the water vapor is cooled by the cooling fan 54 into water (liquid), and temporarily accumulated in the water recovery tank 55. The recovered water is circulated to the mixing tank 45 by the water recovery pump 56. Thus, a dilution circulation system 62 for diluting high-concentration methanol is implemented.

As is evident from the power generation mechanism of the fuel cell unit 10 by this dilution circulation system 62, to take out power from the DMFC stack 42, i.e., to start power generation, the auxiliary equipment 63 such as pumps 44, 46, 50, and 56; valves 48, 51, and 57; and cooling fan 54 in all sections are driven. Thereby, a methanol aqueous solution and air (oxygen) are injected into the DMFC stack 42, and an electrochemical reaction progresses there, thus providing electric power. Conversely, in order to stop power generation, the driving of the auxiliary equipment 63 is stopped.

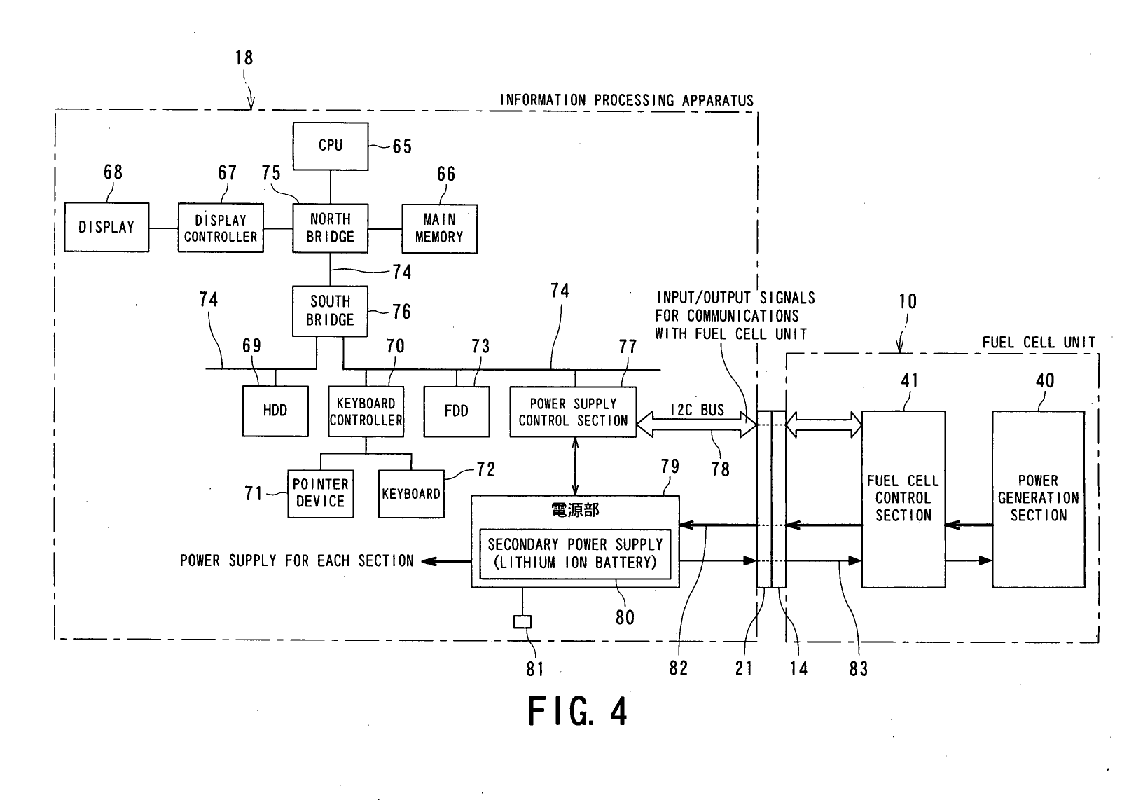

FIG. 4 shows a system configuration of the information processing apparatus 18 to which the fuel cell unit is connected.

The information processing apparatus 18 comprises a CPU 65, main memory 66, display controller 67, display 68, hard disk drive (HDD) 69, keyboard controller 70, pointer device 71, keyboard 72, floppy® disk drive (FDD) 73, bus 74 for transmitting signals between the above-described constituent components, and so-called north bridge 75 and south bridge 76 each serving as a device for converting signals transmitted through the bus 74. Also, the information processing apparatus 18 has therein a power supply section 79, which holds, e.g., a lithium ion battery as a secondary battery 80. The power supply section 79 is controlled by a control section 77 (hereinafter referred to as a power supply control section 77).

As electric interfaces between the fuel cell unit 10 and information processing apparatus 18, there are provided a control system interface and a power supply system interface. The control system interface is an interface provided for performing communications between the power supply control section 77 of the information processing apparatus 18 and the control section 41 of the fuel cell unit 10. Communications performed between the information processing apparatus 18 and fuel cell unit 10 via the control system interface is carried out through a serial bus such as an I2C bus 78.

The power supply system interface is an interface provided for exchanging power between the fuel cell unit 10 and information processing apparatus 18. For example, power generated by the DMFC stack 42 in the power generation section 40 is supplied to the information processing apparatus 18 through the control section 41 (hereinafter referred to as fuel cell control section 41) and the docking connectors 14 and 21. The power supply system interface also includes power supply 83 provided from the power supply section 79 of the information processing apparatus 18 to the auxiliary equipment 63 and the like in the fuel cell unit 10.

A direct-current power supply that has been subjected to AC/DC conversion is supplied to the power supply section 79 of the information processing apparatus 18 through a connector 81 for AC adapter, thereby allowing operations of the information processing apparatus 18 and charging of the secondary battery (lithium ion battery) 80.

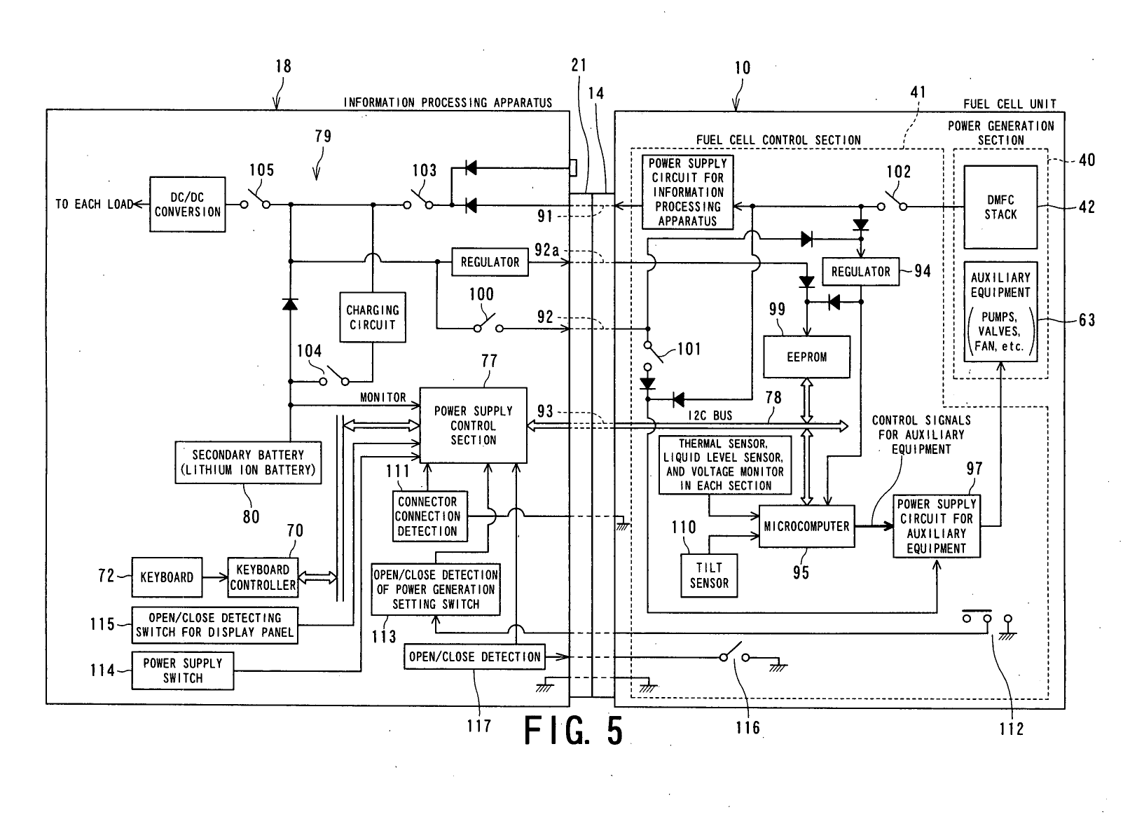

FIG. 5 is a construction example showing the connection relationship between the fuel cell control section 41 of the fuel cell unit 10 and the power supply section 79 of the information processing apparatus 18.

The fuel cell unit 10 and information processing apparatus 18 are mechanically and electrically connected with each other by the docking connectors 14 and 21. The docking connectors 14 and 21 include a first power supply terminal (output power supply terminal) 91 for supplying power generated by the DMFC stack 42 in the fuel cell unit 10 to the information processing apparatus 18; and a second power supply terminal (input power supply terminal for auxiliary equipment) 92 for supplying power to a microcomputer 95 in the fuel cell unit 10 through a regulator 94, and supplying a power to a power supply circuit 97 for auxiliary equipment through a switch 101. Also, the docking connectors 14 and 21 have a third power supply terminal 92a for supplying power from the information processing apparatus 18 to an EEPROM 99.

In addition, the docking connectors 14 and 21 have an input/output terminal 93 for communications for performing communications between the power supply control section 77 of the information processing apparatus 18 and the microcomputer 95 in the fuel cell unit 10, and for performing communications between the power supply control section 77 and the writable nonvolatile memory (EEPROM) 99.

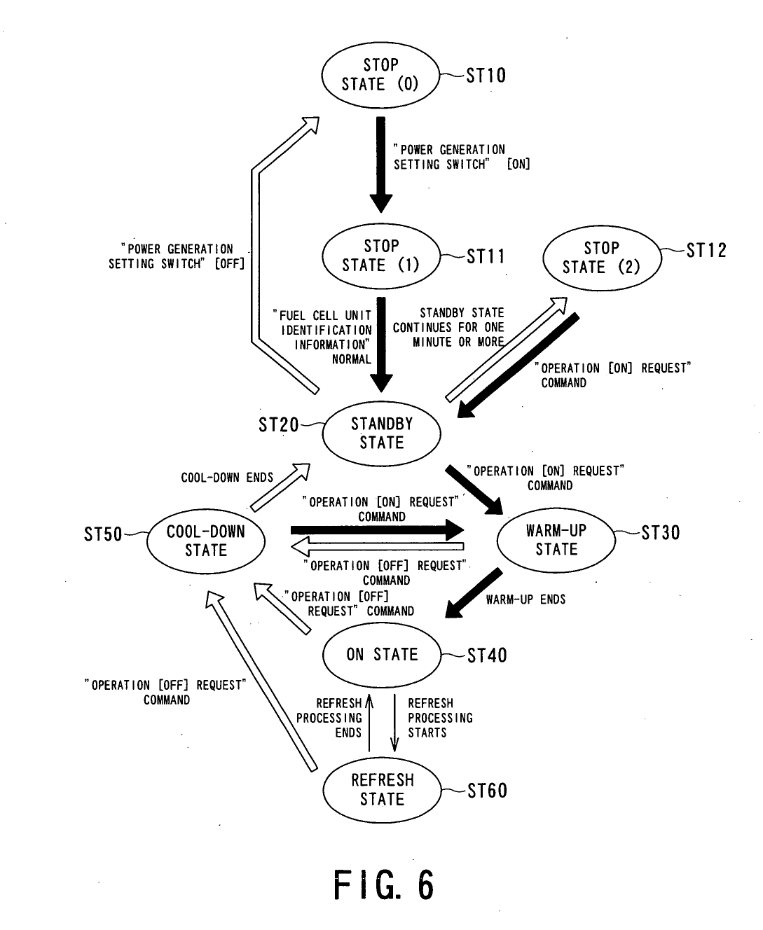

Next, with reference to a connection diagram shown in FIG. 5 and a state transition diagram of the fuel cell unit 10 shown in FIG. 6, descriptions will be made of the basic flow of processing carried out until power generated by the DMFC stack 42 in the fuel cell unit 10 is supplied from the fuel cell unit 10 to the information processing apparatus 18.

Here, it is assumed that the secondary battery (lithium ion battery) 80 in the information processing apparatus 18 has been charged with predetermined power. It is also assumed that all of the switches shown in FIG. 5 are open.

First, based on a signal outputted from a connector connection detecting section 111, the information processing apparatus 18 recognizes that the information processing apparatus 18 and the fuel cell unit 10 have been mechanically and electrically connected with each other. This recognition is effected by detecting that the connector connection detecting section 111 is grounded within the fuel cell unit 10 by the connection of the docking connectors 11 and 21, for example, based on an input signal inputted into the connector connection detecting section 111.

Also, the power supply control section 77 of the information processing apparatus 18 recognizes whether the power generation setting switch 111 of the fuel cell unit 10 is set to the power generation permission setting or a power generation prohibition setting. For example, based on a signal inputted into a power generation setting switch detecting section 113, the power generation setting switch detecting section 113 detects whether the power generation setting switch 112 is in a grounded position or an open position in accordance with its set state. If the power generation setting switch 112 is in an open state, the power supply control section 77 recognizes the setting of the power generation setting switch 112 as the power generation prohibition setting.

The state where the power generation setting switch 112 is set to the power generation prohibition setting, is a state corresponding to a “stop state (0)” ST10 in a state transition diagram in FIG. 6.

Once the information processing apparatus 18 and fuel cell unit 10 have been mechanically connected with each other through the docking connectors 14 and 21, power is supplied from the information processing apparatus 18 side through the third power supply terminal 92a to the nonvolatile memory (EEPROM) 99 serving as storage part of the fuel cell control section 41. In this EEPROM 99, identification information and the like on the fuel cell unit 10 is stored in advance. The identification information may include information such as component codes, production serial numbers, and rated outputs of the fuel cell unit 10. The EEPROM 99 is connected to the serial bus such as the I2C bus 78, and data stored in the EEPROM 99 is readable in a state where the EEPROM 99 is being supplied with a power supply. With the arrangement shown in FIG. 5, the power supply control section 77 can read information stored in the EEPROM 99 through the input/output terminal 93 for communications.

In this situation, the fuel cell unit 10 has not yet generated power, and the inside of the fuel cell unit 10 is in a state where no power is supplied except for the EEPROM 99.

Here, when the user sets the power generation setting switch 112 to the power generation permission setting (in FIG. 5, the power generation setting switch 112 is set to the grounded state side), the power supply control section 77 of the information processing apparatus 18 can read identification information stored in the EEPROM 99 in the fuel cell unit 10. This is a state corresponding to a “stop state (1)” ST11 shown in FIG. 6.

In other words, unless the user sets the power generation setting switch 112 to the power generation permission setting, that is, as long as setting is the power generation prohibition setting, the fuel cell unit 10 is in a state corresponding to the “stop state (0)” ST10, which allows power generation in the fuel cell unit 10 to be prohibited.

Here, it is preferable that the power generation setting switch be one that can be held at either one of “open” and “close” positions, as in the case of a slide switch or the like.

The reading of identification information by the power supply control section 77 is performed by reading identification information on the fuel cell unit 10, stored in the EEPROM 99 of the fuel cell unit 10, through the serial bus such as the I2C bus 78.

When, based on the identification information that has been read, the power supply control section 77 determines that the fuel cell unit 10 connected to the information processing apparatus 18 is a fuel cell unit conforming to the information processing apparatus 18, the state shown in FIG. 6 transitions from the “stop state (1)” ST11 to a “standby state” ST20.

Specifically, by closing a switch 100 provided in the information processing apparatus 18, the power supply control section 77 of the information processing apparatus 18 supplies power from the secondary battery 80 to the fuel cell unit 10 through the second power supply terminal 92, and the power is supplied to the microcomputer 95 through the regulator 94.

In this “standby state” ST20, the switch 101 provided in the fuel cell unit 10 is open, and the power supply circuit for auxiliary equipment 97 is not supplied with power. In this state, therefore, the auxiliary equipment 63 is inactive.

However, the microcomputer 95 has come into action, and is in a state of being capable of receiving various control commands from the power supply control section 77 in the information processing apparatus 18 through the I2C bus 78. The microcomputer 95 is also in a state of being capable of transmitting power supply information on the fuel cell unit 10 to the information processing apparatus 18 through the I2C bus 78.

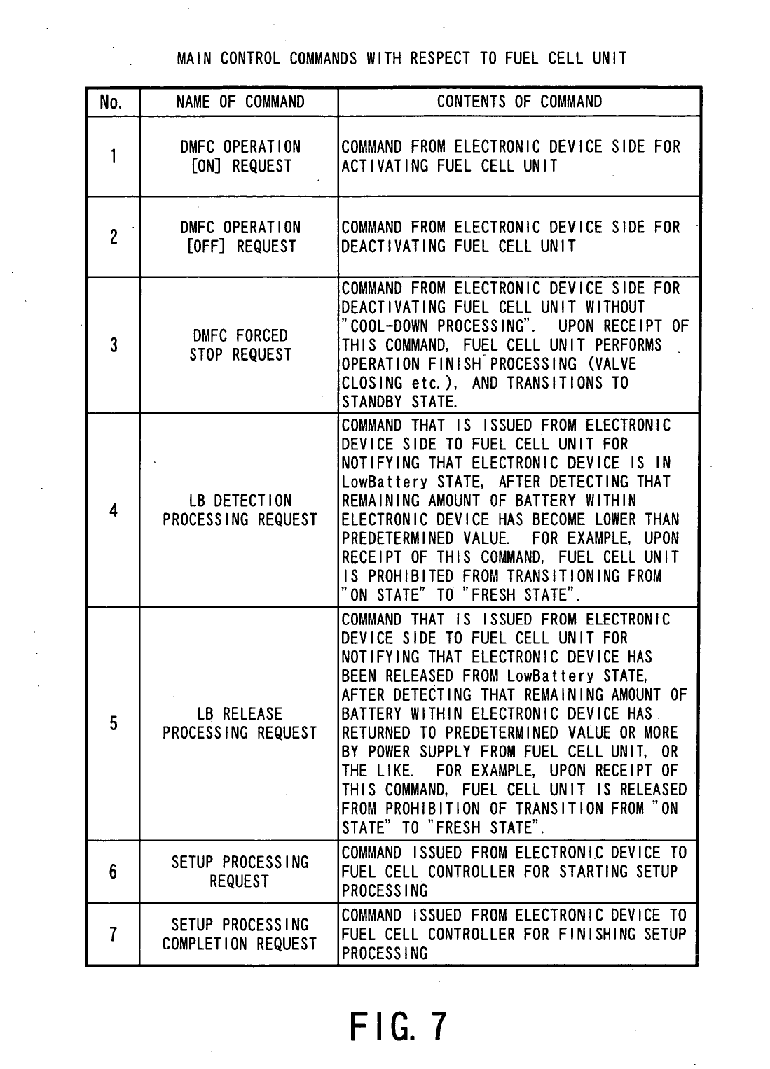

FIG. 7 is a table showing examples of control commands sent from the power supply control section 77 of the information processing apparatus 18 to the microcomputer 95 in the fuel cell control section 41.

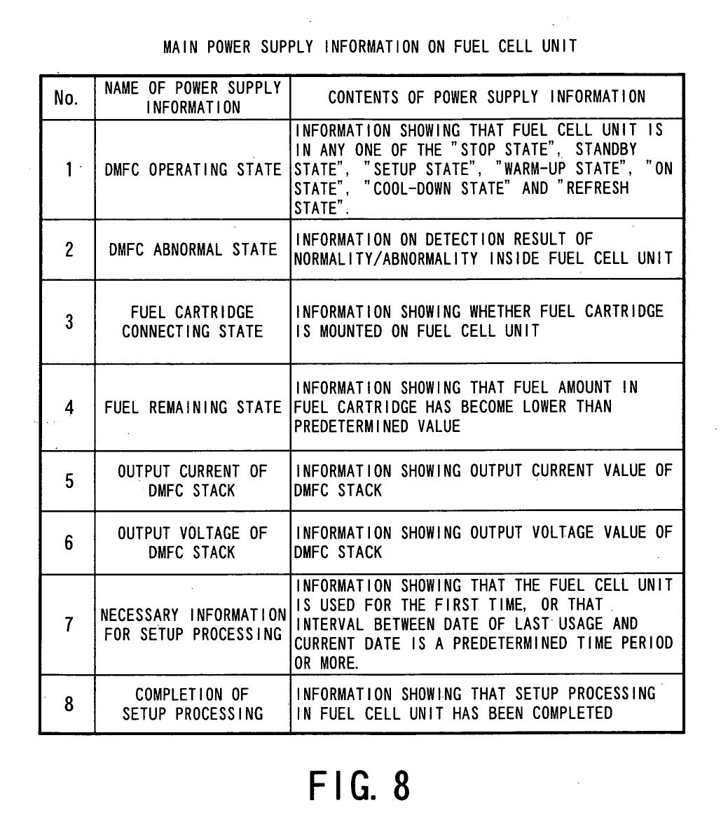

On the other hand, FIG. 8 is a table showing an example of power supply information sent from the microcomputer 95 in the fuel cell control section 41 to the power supply control section 77 of the information processing apparatus 18.

The power supply control section 77 of the information processing apparatus 18 recognizes that the fuel cell unit 10 is in a “standby state” ST20, by reading “DMFC operating state” (No. 1 in FIG. 8) out of the power supply information shown in FIG. 8.

In this “standby state” ST20, when the power supply control section 77 sends a “DMFC operation ON request” command (power generation start command) out of control commands shown in FIG. 7, to the fuel cell control section 41, the fuel cell control section 41 that has received this command causes the state of the fuel cell unit 10 to transition to a “warm-up state” ST30.

Specifically, the microcomputer 95 controls the switch 101 provided in the fuel cell control section 41 to close, thereby supplying the power supply circuit 97 for auxiliary equipment with power supply from the information processing apparatus 18. In addition, by its control signals for auxiliary equipment, the microcomputer 95 drives the auxiliary equipment 63 in the power generation section 40, that is, each of the pumps 44, 46, 50, and 56; the valves 48, 51, and 57; the cooling fan 54 and the like shown in FIG. 4. Furthermore, the microcomputer 95 closes a switch 102 provided in the fuel cell control section 41.

As a result, methanol aqueous solution and/or air is injected into the DMFC stack 42 in the power generation section 40, thereby starting power generation. Also, the power generated by the DMFC stack 42 starts to be supplied to the information processing apparatus 18. However, because the power generation output does not instantly arrive at its rated value, the state up until the arrival of the power generation output at its rated value is referred to as a “warm-up state” ST30.

Once the microcomputer 95 in the fuel cell control section 41 determines that the output of the DMFC stack 42 has arrived at its rated value, by monitoring, e.g., the output voltage and temperature of the DMFC stack 42, it opens the switch 101 in the fuel cell unit 10, and switches the power supply source for the auxiliary equipment 63 from the information processing apparatus 18 to the DMFC stack 42. This state corresponds to an “ON state” ST40.

The foregoing is a summary of the state transition from the “stop state” ST10 to the “ON state” ST40.

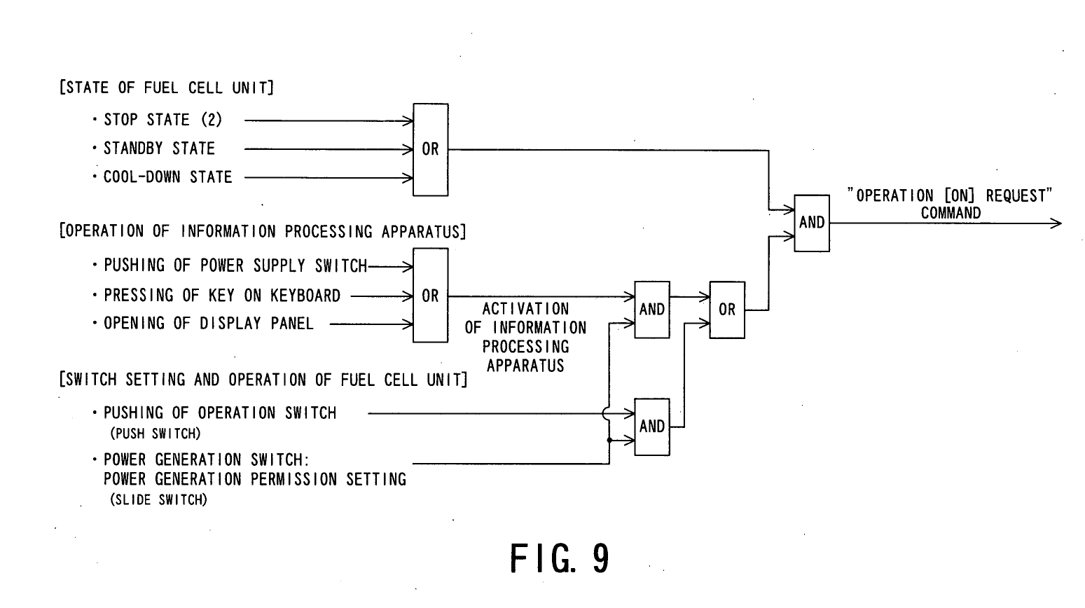

FIG. 9 is a logic diagram showing conditions for the power supply control section 77 of the information processing apparatus 18 to transmit the “DMFC operation ON request” command to the microcomputer 95 in the information processing apparatus 18.

First, the first condition for the “DMFC operation ON request” command to be transmitted is that the fuel cell unit 10 is in any one of the “stop state (2)” ST12, “standby state” ST20, and “cool-down state” ST50. As can be seen from the state transition diagram in FIG. 6, each of these three states is one that is possible only when the power generation switch is set to the power generation permission setting.

The second condition for the “DMFC operation ON request” command to be transmitted is that the information processing apparatus 18 is activated by some information processing apparatus activating means included in the information processing apparatus 18. A possible example of information processing apparatus activating means is an ON-operation of a power supply switch 114 provided in the information processing apparatus 18. The information processing apparatus 18 is activated by the power supply control section 77 detecting that power supply switch 114 has been pushed.

Besides, with the information processing apparatus 18 being a notebook personal computer for example, when its display panel is closed during operations, the information processing apparatus 18 once stops its operation, but when the display panel is reopened, the information processing apparatus 18 restarts. In this case, a switch 115 mechanically detecting that the display panel has been opened, constitutes information processing apparatus activating means.

Also, when the information processing apparatus 18 is not operated for a predetermined time period during operation, the information processing apparatus 18 goes into a resume mode chiefly for the purpose of power saving. However, for example, when the keyboard controller 70 detects that any key on the keyboard has been pressed, the power supply control section 77 can restart the information processing apparatus 18 based on the above-described detected information. In this case, the keyboard controller, serving as detecting means, constitutes information processing apparatus activating means.

As described above, the second condition for the “DMFC operation ON request” command to be transmitted is an activating operation with respect to the information processing apparatus 18 in any event.

Therefore, without being aware that the power supply of the information processing apparatus 18 is the fuel cell unit 10, the user can cause the fuel cell unit 10 transition to a stationary power generation state, i.e., the “ON state” ST40 by the activation method of the information processing apparatus 18.

Specifically, the first condition for the “DMFC operation ON request” command to be transmitted is to mount the fuel cell unit 10 onto the information processing apparatus 18 through the docking connectors 14 and 21; to set the power generation setting switch 112 to the power generation permission setting; and to cause the fuel cell unit 10 to automatically transitioned to the “standby state” ST20.

As described above, according to the present invention, even the information processing apparatus using the fuel cell unit 10 as a power supply, is capable of simplifying the handling of the apparatus and enhance conveniences for the user by proceeding with the sequence of power generation start of the fuel cell unit 10 in cooperative association with the starting procedure of the information processing apparatus 18.

The state transition diagram in FIG. 6 shows a “stop state (2)” ST12. The “stop state (2)” ST12 is a state to which the “standby state” ST20 is forced to transition when the “standby state” ST20 has continued for a predetermined time period or more, for example, one minute or more. Specifically, this state control is such that, when the “DMFC operation ON request” command is not transmitted from the information processing apparatus 18 for a predetermined time period or more under the “standby state” ST20, the power supply control section 77 stops power supply from the secondary battery 80 in the information processing apparatus 18 to the fuel cell unit 10 (i.e., the switch 100 in the information processing apparatus 18 is opened), and when a cause of transmitting the “DMFC operation ON request” command has occurred (e.g., when the power supply switch 114 in the information processing apparatus 18 has been pushed), the power supply control section 77 closes again the switch 100, and then transmits the “DMFC operation ON request” command to the microcomputer 95 in the fuel cell unit 10.

Next, description will be made of the basic sequence of power generation stop of the fuel cell unit 10.

The power supply control section 77 in the information processing apparatus 18 reads power supply information on the microcomputer 95 in the fuel cell unit 10 through the I2C bus 78, and thereby it recognizes that the DMFC operation state (No. 1 in FIG. 8) is either one of the “warm-up state” ST30 and “ON state” ST40.

Here, the basic sequence of power generation stop of the fuel cell unit 10 is explained taking the “ON state” ST40, which is one of states where the sequence of power generation stop is started, as an example.

With the fuel cell unit 10 being in the “ON state” ST40, when the “DMFC operation OFF request” command (power generation stop command) is transmitted from the power supply control section 77 to the microcomputer 95 in the fuel cell unit 10, the fuel cell unit 10 transitions from the “ON state” ST40 to the “cool-down state” ST50 (refer to FIG. 6).

The contents of the “cool-down state” ST50 are as follows:

First, the microcomputer 95 closes the switch 101 in the fuel cell unit, and thereby switches the power source for the power supply circuit 97 for auxiliary equipment used for driving the auxiliary equipment 63, to the secondary battery 80 to be power-supplied to the auxiliary equipment 63 through the second power supply terminal 92.

Furthermore, the microcomputer 95 opens the switch 102 in the fuel cell unit, and thereby stops supply of power generated by the DMFC stack 42 to the information processing apparatus 18.

Next, the microcomputer 95 stops the air feed pump 50, as well as operates the liquid feed pump 46, and maintains the pump operating state for a predetermined time period. This operation allows bubbles of carbide dioxide adhering to the inside of the liquid feed channels within the fuel electrodes 47 to be run off or removed.

Then, the microcomputer 95 stops the liquid feed pump 46, and operates the air feed pump 50 at its maximum capacity. This pump operating state is maintained for a predetermined time period. This operation allows water drops adhering to the inside of the air feed channels within the air electrodes 52 to be run off or removed.

By automatically running off or removing bubbles or water drops occurring due to the power generation by the DMFC stack during the sequence of power generation stop, it is possible to improve the power generation efficiency when starting next time power generation.

Thereafter, in order to avoid the intrusion of undesired substances from the ambient air surrounding the fuel cell unit 10, and the leakage of liquid fuel set in the fuel cell unit 10, the exhaust valve 57 and/or air feed valve 51 is closed. Moreover, the microcomputer 95 stops power supply from the power supply circuit 97 for auxiliary equipment to the auxiliary,, equipment 63.

The foregoing is the processing contents of the “cool-down state” ST50 performed in the fuel cell unit 10.

The processing of the “cool-down state” ST50 is performed for about 30 s for example, and after having completed the cool-down, the DMFC operation state (refer to No. 1 in FIG. 8) is automatically set to the “standby state” ST20.

The power supply control section 77 in the information processing apparatus 18 reads the power supply information (information shown in FIG. 8) on the fuel cell unit 10 through the I2C bus 78 for each predetermined time period, e.g., for each 100 ms, and recognizes that the power supply information on the fuel cell unit 10 has become the “standby state” ST20.

Besides, as shown in FIG. 6, the fuel cell unit 10 has a “refresh state” ST60. The “refresh state” ST60 is intended for maintaining the power generation efficiency of the fuel cell unit 10. The fuel cell unit 10 automatically transitions from the “ON state” ST40 to the “refresh state” ST60 for every predetermined time period, and after the refresh processing for the predetermined time period has been completed, it automatically returns to the “ON state” ST40.

The contents of the refresh processing is similar to those of the “cool-down state” ST50, and intended for running off or removing undesired bubbles and/or water drops occurring inside of the air feed channels and/or the liquid feed channels in the DMFC stack.

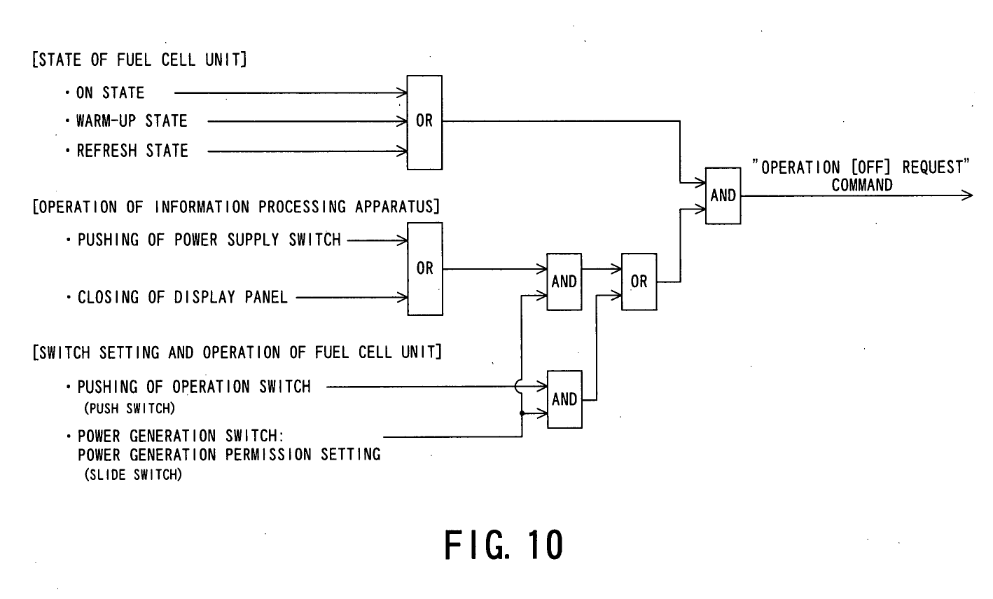

FIG. 10 is a logic diagram showing conditions for the power supply control section 77 to transmit the “DMFC operation OFF request” command to the microcomputer 95.

The first condition for the power supply control section 77 to transmit the “DMFC operation OFF request” command is that the fuel cell unit 10 is in any one of the “warm-up state” ST30, “ON state” ST40, and “refresh state” ST60. As can be seen from the state transition diagram in FIG. 6, each of these three states is one where the power generation setting switch is set to power generation permission setting.

The second condition for the power supply control section 77 to transmit the “DMFC operation OFF request” command is that the information processing apparatus 18 is stopped by some information processing apparatus stopping means included in the information processing apparatus 18. A possible example of information processing apparatus stopping means is the power supply switch 114 in the information processing apparatus 18. The information processing apparatus 18 is stopped by the power supply control section 77 detecting that power supply switch 114 has been pushed.

Besides, when the information processing apparatus 18 is a notebook personal computer for example, the information processing apparatus 18 can be stopped by closing its display panel during operations. In this case, a switch 115 detecting that the display panel has been closed, constitutes information processing apparatus stopping means.

As described above, the second condition for the power supply control section 77 to transmit the “DMFC operation OFF request” command is a stopping operation with respect to the information processing apparatus 18 in any event.

Therefore, without being aware that the power supply of the information processing apparatus 18 is the fuel cell unit 10, the user can cause the fuel cell unit 10 transition from the “ON state” ST40 through the “cool-down state” ST50 to the “standby state” ST20 by the stopping method of the information processing apparatus 18.

As shown in FIG. 6, in the case where the fuel cell unit 10 is either in the “warm-up state” ST30 or in the “refresh state” ST60, even when the power supply control section 77 transmits the “DMFC operation OFF request” command, the fuel cell unit 10 transitions to the “standby state” ST20 through the “cool-down state” ST50.

As described above, even the information processing apparatus using the fuel cell unit 10 as a power supply, is capable of simplifying the handling of the apparatus and enhance conveniences for the user by proceeding with the sequence of power generation stop of the fuel cell unit 10 in cooperative association with the stopping procedure of the information processing apparatus 18.

When the remaining amount of the secondary battery 80 is less than a predetermined value, the power supply control section 77 may transmit the “DMFC operation OFF request” command after having charged the secondary battery 80 up to the predetermined value or more.

Besides, the fuel cell unit 10 has the operation switch 116, which is constituted of a push switch for example.

In the case where the fuel cell unit 10 is in the “standby state” ST20 or the “stop state (2)” ST12, for example, because the power generation setting switch 112 is set to the power generation permission, the operation switch 116 is used when a power generation sequence of the fuel cell unit 10 is started. In this case, without the use of the information processing apparatus activating means, the sequence of power generation start is started by the power supply control section 77 detecting that the operation switch 116 in the fuel cell unit 10 has been pushed and transmitting the “DMFC operation ON request” command to the microcomputer 95.

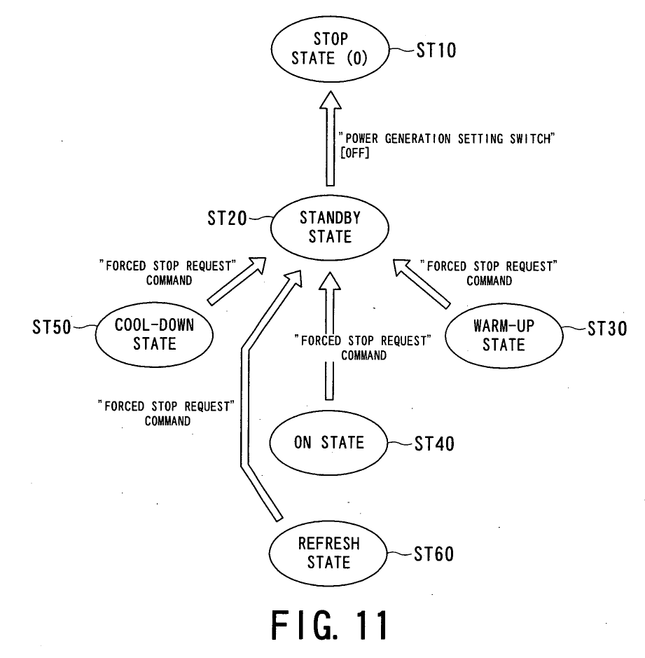

FIG. 11 is diagram showing a state transition in which the fuel cell unit 10 is brought to an emergency stop.

In the case where the fuel cell unit 10 is in any one of the “warm-up state” ST30, “ON state” ST40, and “cool-down state” ST50, when the power supply control section 77 transmits a “forced stop request command” to the microcomputer 95, the air feed valve 51, exhaust valve 57, and mixing tank valve 48 are closed, without the fuel cell unit 10 passing through the “cool-down state” ST50, or with cool-down processing stopped at halfway stage if the fuel cell unit 10 is in the “cool-down state” ST50, and thereafter the fuel cell unit 10 transitions to the “standby state” ST20. Then, the power supply control section 77 opens the switch 100 in the information processing apparatus 18 to stop power supply from the secondary battery 80, and causes the fuel cell unit 10 to transition to the “stop state (0)”.

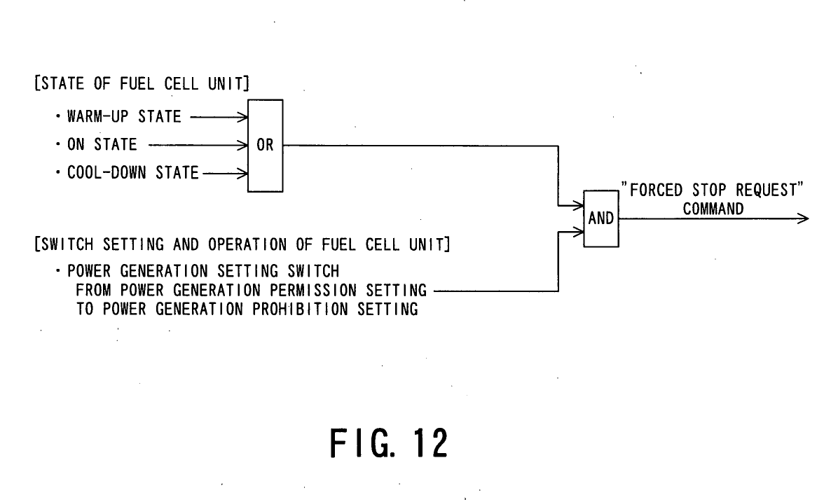

As shown in FIG. 12, a “forced stop request command” is transmitted when the fuel cell unit 10 is in any one of the “warm-up state” ST30, “ON state” ST40 and “cool-down state” ST50 (first condition), and when the setting of the power generation setting switch 112 is changed from the power generation permission setting to the power generation prohibition setting (second condition).

Thus, when the necessity to urgently stopping power generation of the fuel cell unit 10 occurs for one reason or another, setting of the power generation setting switch 112 to the power generation prohibition setting allows power generation to be stopped in a short time.

The present invention is not limited to the above-described embodiment, but may be embodied by modifying its components in its implementation stage without departing its true spirit. Also, various aspects of invention can be constituted by appropriately combining a plurality of components disclosed in the above-described embodiment. For example, some components may be eliminated out of all components shown in the embodiment. Moreover, components across different embodiments may be combined as appropriate.

What is claimed is:

1. A fuel cell unit comprising:
a connection section used for establishing connection with an external device;
fuel cells for generating power to be supplied to the external device through the connection section;
a setting switch settable to power generation permission setting for permitting power generation using the fuel cells; and
a control section capable of controlling the power generation using the fuel cells when the setting switch is set to the power generation permission setting.

2. The fuel cell unit according to claim 1, wherein the control section starts the power generation using the fuel cells in accordance with a predetermined operation performed in the external device.

3. The fuel cell unit according to claim 1, further comprising:
auxiliary equipment for supplying at least fuel to the fuel cells,
wherein, when the setting switch is set to the power generation permission setting, the control section starts the power generation using the fuel cells by supplying power supplied from the external device to the auxiliary equipment, to thereby drive the auxiliary equipment.

4. The fuel cell unit according to claim 3, wherein after the power generation using the fuel cells has been started, the control section stops the supply of the power from the external device to the auxiliary equipment, and supplies power generated by the fuel cells to the auxiliary equipment.

5. The fuel cell unit according to claim 1, further comprising:
a switch for starting the power generation using the fuel cells,
wherein, when the setting switch is set to power generation permission setting, the control section starts the power generation using the fuel cells in accordance of an operation of the switch.

6. The fuel cell unit according to claim 1, wherein the control section stops the power generation using the fuel cells in accordance with the predetermined operation performed in the external device.

7. The fuel cell unit according to claim 6, further comprising:
auxiliary equipment for supplying at least fuel to the fuel cells,
wherein the control section supplies the power supplied from the external device to the auxiliary equipment, prior to stopping the supply of the power generated by the fuel cells to the external device.

8. The fuel cell unit according to claim 7, wherein the control section drives the auxiliary equipment for a predetermined time period, after having stopped the supply of the power generated by the fuel cells to the external device.

9. The fuel cell unit according to claim 1,
wherein the setting switch is a switch settable to power generation prohibition setting for prohibiting the power generation using the fuel cells; and
wherein, when the setting of the setting switch is changed from the power generation permission setting to the power generation prohibition setting, the control section stops the power generation using the fuel cells.

10. An information processing apparatus connectable to a fuel cell unit having fuel cells, the apparatus comprising:
activating means for activating the information processing apparatus; and
a control section for starting power generation using the fuel cells when the information processing apparatus is activated by the activating means.

11. The information processing apparatus according to claim 10, wherein, when the power generation using the fuel cells is permitted, the control section starts the power generation using the fuel cells.

12. The information processing apparatus according to claim 10, further comprising:
a power supply section that supplies power for driving auxiliary equipment for supplying fuel to the fuel cells,
wherein the control section starts power generation using the fuel cells, by controlling the power supply section to supply power to the auxiliary equipment to thereby drive the auxiliary equipment.

13. The information processing apparatus according to claim 10, further comprising:
stopping means for stopping the information processing apparatus;
wherein, when the information processing apparatus is stopped by the stopping means, the control section stops the power generation using the fuel cells.

14. The information processing apparatus according to claim 10, wherein, when the power generation using the fuel cells is prohibited, the control section stops the power generation using the fuel cells.

15. The information processing apparatus according to claim 10, further comprising:
a power supply section that supplies power for driving auxiliary equipment for supplying fuel to the fuel cells,
wherein the control section controls the power supply section to supply power to the auxiliary equipment, prior to stopping the power generation using the fuel cells.

16. The information processing apparatus according to claim 10, further comprising:
a secondary battery that supplies power for driving the auxiliary equipment for supplying fuel to the fuel cells,
wherein, when the remaining amount of the secondary battery is not less than a predetermined amount, the control section stops the power generation using the fuel cells.

17. A power supply controlling method for an information processing apparatus that receives power generated by fuel cells, the method comprising:
activating the information processing apparatus; and
starting power generation using the fuel cells when activating the information processing apparatus.

18. The power supply controlling method according to claim 17, wherein, when the information processing apparatus is activated, the power generation using the fuel cells is started by supplying power from the information processing apparatus to auxiliary equipment that supply at least fuel to the fuel cells, to thereby drive the auxiliary equipment.

19. The power supply controlling method according to claim 17, the method further comprising:
deactivating the information processing apparatus; and
stopping the power generation using the fuel cells when deactivating the information processing apparatus.

20. The power supply controlling method according to claim 19, wherein, when the power generation using the fuel cells is stopped, power is supplied from the information processing apparatus to auxiliary equipment that supplies at least fuel to the fuel cells.
